(19) United States
(12) Patent Application Publication
(10) Pub. No.: US 2019/0002180 A1
(43) Pub. Date: Jan. 3, 2019

(54) POUCH FOR HOLDING A FLUID

(71) Applicant: TECHNOFLEX, BIDART (FR)

(72) Inventors: NICOLAS CHATO, CIBOURE (FR); FRÉDÉRIC BONNET, BAYONNE (FR)

(21) Appl. No.: 16/065,051

(22) PCT Filed: Dec. 20, 2016
(86) PCT No.: PCT/FR2016/053568

§ 371 Date: Jun. 21, 2018

(30) Foreign Application Priority Data
Dec. 24, 2015 (FR) 1563297

(51) Int. Cl. B65D 81/32; A61J 1/10; A61J 1/20

(52) U.S. Cl. CPC B65D 81/3266; A61J 1/2093; A61J 1/10

(57) ABSTRACT

A pouch to hold a fluid. The pouch includes at least two compartments and at least two outlets that are each connected to a tube in each of the compartments. One compartment has a geometry that optimizes the volume of the pouch in order to prevent the pouch from collapsing at an acceptable maximum pressure.

### FIELD OF THE INVENTION

This invention relates to the field of pouches able to hold liquids.

This invention relates more particularly to a pouch able to hold a fluid and that has a particular geometry that makes it possible to prevent collapsing and reflux.

### PRIOR ART

Pouches able to hold liquids comprising one or several compartment(s) are known from prior art.

Pouches that have several compartments comprise a tube that allows for the filling of said pouch and a weld that separates the compartments.

During the filling of these pouches, if the distance between the outlet of the tube and the welded zone is too weak, the tension of the film does not necessarily allow for filling, because a reflux phenomenon can be observed.

In the case of a straight weld that complies with the filling distance, the compartment may be too large, and collapsing is observed on the outer edges of the compartment.

FIGS. 1 and 2 show a pouch according to prior art. In FIG. 2, a collapsing is observed on the outer edges of the compartment.

### SUMMARY OF THE INVENTION

This invention intends to overcome the disadvantages of prior art by proposing a pouch able to hold a fluid, which makes it possible to prevent collapsing and reflux.

To this effect, this invention relates, in its broadest form, to a pouch able to hold a fluid comprising at least two compartments and at least two outlets that are each connected to a tube in each of said compartments, wherein one compartment has a geometry that optimizes the volume of said pouch in order to prevent the pouch from collapsing at an acceptable maximum pressure.

The pouch according to this invention makes it possible to homogenise the pressure within the compartment, which makes it possible to prevent collapsing and reflux.

According to an embodiment, the edge of said compartment opposite the outlet of the tube has the shape of an arc of a circle.

According to another embodiment, the edge of said compartment opposite the outlet of the tube has a shape comprised of a plurality of arcs of a circle.

According to another embodiment, the edge of said compartment opposite the outlet of the tube is comprised of a succession of curves and straight lines.

Advantageously, the two compartments are separated by a weld, and said weld is peelable.

According to an alternative, the volume of one compartment is between 4 ml and 30 ml.

According to an embodiment, the volume of one compartment is 7 ml and the volume of the other compartment is 93 ml.

According to an embodiment, the volume of one compartment is 20 ml and the volume of the other compartment is 500 ml.

According to an embodiment, the volume of one compartment is 10 ml and the volume of the other compartment is 100 ml.

### BRIEF DESCRIPTION OF THE DRAWINGS

The invention shall be better understood using the description, provided hereinafter solely for the purposes of explanation, of an embodiment of the invention, in reference to the Figures wherein:

FIGS. 1 and 2 show a pouch according to prior art; and

FIGS. 3 and 4 show a pouch according to this invention.

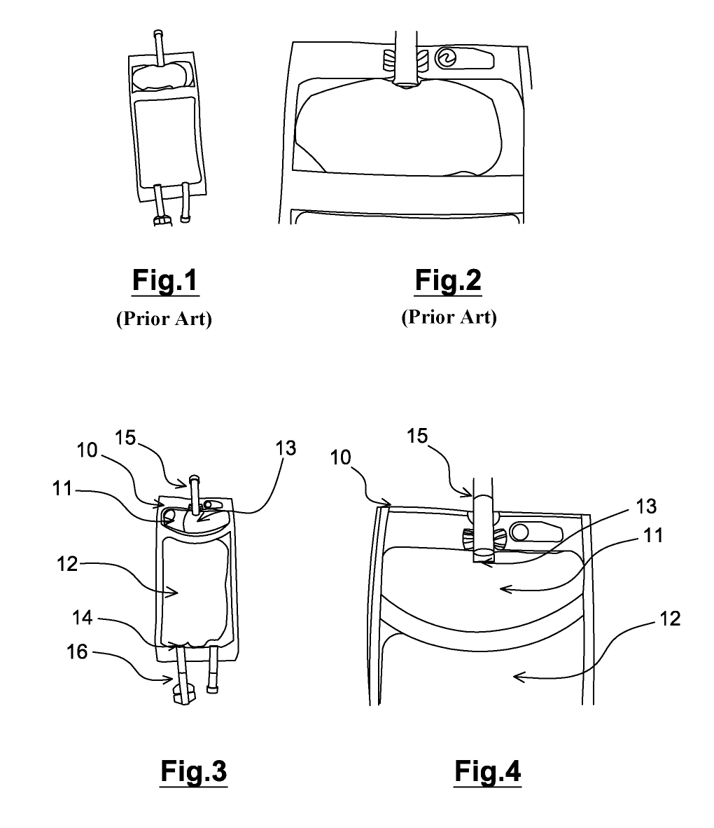

### DETAILED DESCRIPTION OF THE EMBODIMENTS OF THE INVENTION

This invention relates to a pouch 10 able to hold a fluid comprising at least two compartments 11, 12 and at least two outlets 13, 14 that are each connected to a tube 15, 16 in each of said compartments 11, 12, wherein one compartment 11 has a geometry that optimizes the volume of said pouch 10 in order to prevent the pouch from collapsing at an acceptable maximum pressure.

FIGS. 3 and 4 show a pouch 10 according to this invention.

In the FIGS. 3 and 4, a pouch 10 according to this invention can be seen. This pouch comprises two compartments 11 and 12 and two outlets 13 and 14 that are each connected to a tube 15, 16. It can be seen in FIG. 4 that this invention makes it possible to prevent collapsing, thanks to an optimisation of the volume and of the pressures inside the pouch 10.

In an embodiment, the edge of said compartment 11 opposite the outlet 13 of the tube 15 has the shape of an arc of a circle.

In an embodiment, the edge of said compartment 11 opposite the outlet 13 of the tube 15 has a shape comprised of a plurality of arcs of a circle.

In another embodiment, the edge of said compartment 11 opposite the outlet 13 of the tube 15 is comprised of a succession of curves and straight lines.

The pouch 10 according to this invention makes it possible to optimise the volume thanks to the pressure exerted on the side walls of the compartment 11.

Thanks to this invention, the total pressure on the pouch 10 is homogenised.

In an embodiment, the two compartments 11, 12 are separated by a weld, and said weld is peelable.

In an embodiment, the volume of the compartment 11 is between 4 ml and 30 ml.

More preferably, the volume of the compartment 12 is greater than the volume of the compartment 11.

In an embodiment, the volume of the compartment 11 is 7 ml and the volume of the compartment 12 is 93 ml.

In another embodiment, the volume of the compartment 11 is 20 ml and the volume of the compartment 12 is 500 ml.

In another embodiment, the volume of the compartment 11 is 10 ml and the volume of the compartment 12 is 100 ml.

The invention is described hereinabove by way of example. It is understood that those skilled in the art are able to produce different alternatives of the invention without however leaving the scope of the patent.

1-9. (canceled)

10. A pouch configured to hold a fluid comprising at least two compartments and at least two outlets, each outlet connected to a tube in each of said at least two compartments, wherein a first compartment has a geometry that optimizes a volume of the pouch in order to prevent the pouch from collapsing at a maximum pressure.

11. The pouch according to claim 10, wherein an edge of the first compartment opposite the outlet of the tube, associated with the first compartment, has a shape of an arc of a circle.

12. The pouch according to claim 10, wherein an edge of the first compartment opposite the outlet of the tube, associated with the first compartment, has a shape resembling a plurality of arcs of a circle.

13. The pouch according to claim 10, wherein an edge of the first compartment opposite the outlet of the tube, associated with the first compartment, comprises a succession of curves and straight lines.

14. The pouch according to claim 10, wherein said at least two compartments are separated by a peelable weld.

15. The pouch according to claim 10, wherein a volume of the first compartment is between 4 ml and 30 ml.

16. The pouch according to claim 10, wherein a volume of the first compartment is 7 ml and a volume of a second compartment is 93 ml.

17. The pouch according to claim 10, wherein a volume of the first compartment is 20 ml and a volume of a second compartment is 500 ml.

18. The pouch according to claim 10, wherein a volume of the first compartment is 10 ml and a volume of a second compartment is 100 ml.
